(19) United States
(12) Patent Application Publication
(10) Pub. No.: US 2005/0122230 A1
(43) Pub. Date: Jun. 9, 2005

(54) FirstMate, the all purpose remote system for boats

(76) Inventor: David Alan Van Leeuwen, Amityville, NY (US)

Correspondence Address: DAVID VAN LEEUWEN, 11 UNQUA PLACE, AMITYVILLE, NY, 11701, US

(21) Appl. No.: 10/707,344

(22) Filed: Dec. 6, 2003

(51) Int. Cl. G08C 19/00

(52) U.S. Cl. 340/825.69

(57) ABSTRACT

A remote control unit for providing remote operation of various electrical applications. This unit provides the convenience of using a remote control in a system designed to withstand the conditions of a marine environment. This unit operates on 12 volts and is easily installed and connected to most electrical application activation switches.

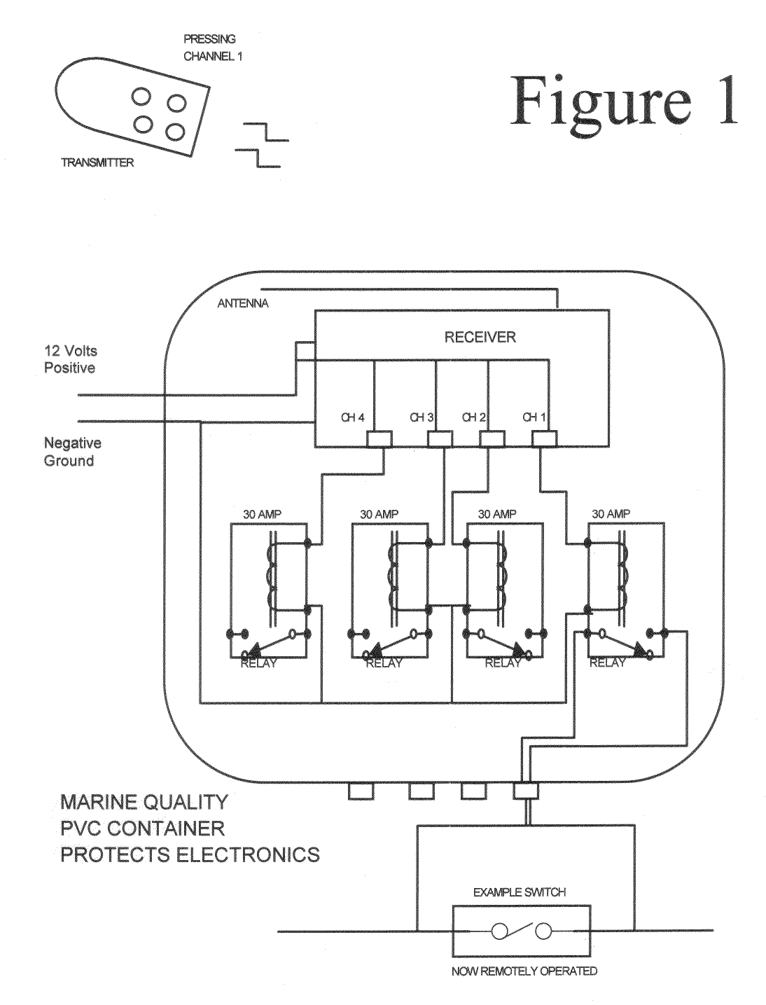

### DETAILED DESCRIPTION

The container is a UL listed marine quality PVC electronics box and is used to house and protect the receiver, wiring and relays. Wiring connections are made through the container using marine grade wire seals. The 12 volt receiver has up to four channels and a wire antenna. Up to four 30-amp relays are operated by the receiver channels and are wired through the container along with the receiver's power wires. A transmitter with up to four channels is used to activate the receiver. The unit is designed to connect to any electronic device switch, giving the transmitter operator remote control of that device while also being able to withstand the conditions of a marine environment.

On board a boat, you are often required to perform many different functions for successful operation. Accordingly, being able to perform some of these functions by use of remote control is desirable. Being able to remotely raise and lower the anchor, activate lighting or operate electrical applications can save time, provide more safety and provide better control. Installing and connecting FirstMate will provide the ability to operate an electrical application from anywhere on board the boat where previously you were required to be at a specific location to press a button.

FirstMate provides the convenience of using a remote control in a system designed to withstand the conditions of a marine environment.

1. A method to provide a remote control unit and transmitter for hookup and operation of electrical applications and capable for use on board boats, said remote control unit comprising: a PVC container (UL Listed Marine quality), weather proof 18 gauge wire, marine grade wire seals, 30-amp relay, inline fuse, 12 volt multi-channel receiver and transmitter.

2. A method according to claim 1 wherein the unit is easily mounted and wired to power source. Wiring for remote operation can be performed in many ways; remote activation causes the N/O relay to close activating the electrical application.

3. A method according to claim 1 wherein the unit and transmitter can activate from one to four different electrical applications depending on need.

4. A method according to claim 1 wherein the units range can be extended by using various receivers and transmitters.

5. A method according to claim 1 wherein the unit is comprised of components designed to withstand the conditions of the marine environment.
